(19) United States
(12) Patent Application Publication
(10) Pub. No.: US 2026/0277678 A1
(43) Pub. Date: Sep. 17, 2026

(54) MULTI-MODEL MEMORY MANAGEMENT

(71) Applicant: NVIDIA Corporation, Santa Clara, CA (US)

(72) Inventors: Sherief Farouk, Santa Clara, CA (US); Ram Rangan, Chennai (IN); Anjul Patney, Kirkland, WA (US)

(21) Appl. No.: 19/079,748

(22) Filed: Mar. 14, 2025

(51) Int. Cl. G06F 9/50

(52) U.S. Cl. CPC G06F 9/5016; G06F 9/5038; G06F 9/5044

(57) ABSTRACT

Disclosed are apparatuses, systems, and methods for allocating graphics processing unit (GPU) memory resources for executing artificial intelligence (AI) models. The systems and methods can allocate a first portion of memory resources of the GPU to a first set of at least one AI model for a task execution. Upon a need for further data processing, identifying a second set of at least one AI model for continuation of the task execution. The systems and methods can determine that an unallocated portion of the memory resources of the GPU are insufficient for the second set of at least one AI model and can reallocate the first portion of the memory resources of the GPU to the second set of at least one AI model.

### TECHNICAL FIELD

At least one embodiment pertains to managing memory resources for task execution and application support. For example, at least one embodiment pertains to managing memory resources for multi-processing computing devices that run real-time interactive applications.

### BACKGROUND

Agentic systems can include multiple agents acting independently to complete objectives that contribute to an overall system behavior. Agents can use artificial intelligence (AI) models for processing and analyzing data. The combination of outputs of multiple AI models can be used to accomplish complex objectives. To process the data, the AI models may utilize memory of graphics processing units (GPUs) to execute the necessary operations. Depending on the complexity of the agentic system, the AI models may require a significant amount of GPU memory.

### BRIEF DESCRIPTION OF DRAWINGS

FIG. 1 is a schematic block diagram of an example system architecture providing agentic system memory resource management, according to at least one embodiment;

FIG. 2 illustrates an example mode-based strategy for memory resource allocation using the agentic system memory resource management architecture of FIG. 1, according to at least one embodiment;

FIG. 3 illustrates an example model-based strategy for memory resource allocation using the agentic system memory resource management architecture of FIG. 1, according to at least one embodiment;

FIG. 4 illustrates an example temporary requisition-based strategy for memory resource allocation using the agentic system memory resource management architecture of FIG. 1, according to at least one embodiment;

FIG. 5 illustrates an example availability-based strategy for memory resource allocation using the agentic system memory resource management architecture of FIG. 1, according to at least one embodiment;

FIG. 6 illustrates an example full utilization strategy for memory resource allocation using the agentic system memory resource management architecture of FIG. 1, according to at least one embodiment;

FIG. 7 is a flow diagram of an example method of agentic system memory resource management, according to at least one embodiment;

FIG. 8A illustrates inference and/or training logic, according to at least one embodiment;

FIG. 8B illustrates inference and/or training logic, according to at least one embodiment;

FIG. 9 illustrates training and deployment of a neural network, according to at least one embodiment;

FIG. 10 is an example data flow diagram for an advanced computing pipeline, according to at least one embodiment;

FIG. 11 is a system diagram for an example system for training, adapting, instantiating and deploying machine learning models in an advanced computing pipeline, according to at least one embodiment;

FIG. 12A is a block diagram of an example generative language model system suitable for use in implementing at least some embodiments of the present disclosure;

FIG. 12B is a block diagram of an example embodiment in which the generative LM includes a transformer encoder-decoder, according to at least one embodiment;

FIG. 12C is a block diagram of an example embodiment in which the generative LM includes a decoder-only transformer architecture, according to at least one embodiment; and

FIG. 13 is a block diagram of an example computing device suitable for use in implementing some embodiments of the present disclosure.

### DETAILED DESCRIPTION

The present disclosure is directed to managing memory resources for task execution and application support. Devices may have limited graphics processing unit (GPU) memory resources that may not be able to handle computational models that are required for task execution. Task execution may require the use of agentic systems which include multiple agents, such as agents utilizing artificial intelligence (AI) models (e.g., computational models), acting independently to execute a single task. A portion or all agents within an agentic system may require more GPU resources than is available on the device. Existing technologies may store AI models on the GPU, which may cause the applications using the GPU to fail once too much memory is utilized by the models or more memory is requested than is available. Previous solutions have relied on providing data to external devices to execute tasks using the memory resources of the external devices. However, offloading data to external devices for task execution can introduce latency. Even if the GPU remains operational, excessive memory consumption can still cause significant processing delays and degrade the overall performance of the agentic system.

Certain agentic systems benefit especially from lower latency performance. For example, an agentic system can be an AI-powered virtual assistant designed to enhance a gaming experience for a player of a video game. The AI-powered virtual assistant can, upon a prompt from the player, visually interpret data of the game, interpret the prompt from the user, generate a response to the prompt, and provide the response to the user. For the AI-powered virtual assistant to generate and provide the response, the AI-powered virtual assistant can utilize a plurality of models configured to interpret video data, audio data, language data, and the like.

Computer systems, for example video game systems, generally have a limited GPU memory capacity, much of which can be devoted to maintaining the functionality of the primary user-facing applications, for example, a video game. The AI models required for the AI-powered virtual assistant may require more GPU memory than is available due to video game functionality support.

Aspects of the present disclosure improve agentic system functionality in limited GPU memory environments by implementing an agentic system model scheduler. The agentic system model scheduler may be utilized to direct AI models stored in the CPU memory to be loaded onto the GPU based upon GPU memory availability and a need for the AI model to execute data processing tasks. Depending on the GPU capacity available to the agentic system for AI models, the size of the AI models, and other considerations, one or more scheduling strategies may be utilized by the agentic system model scheduler.

One example scheduling strategy referred to herein as a mode-based strategy may include allocating GPU memory to AI models based on a mode of operation of the agentic system. Each mode may require a different set of AI models and, upon indication of a transition into a subsequent mode, GPU memory can be allocated to a next set of AI models. For example, in the context of an AI-powered virtual assistant for a video game, the modes may include: a play mode, an inquiry mode, a processing mode, an answer mode, and the like. The play mode may be a mode in which a player is playing the game and no inquiry has been provided to the system by the player. During the play mode, for example, the agentic system model scheduler may allocate GPU memory to an optical character recognition (OCR) model and/or an object detection (OD) model. The OCR and OD models can be used during the play mode to interpret the visuals (visually represented content) on the screen. During the play mode, the OCR and OD models may continually reinterpret the visuals, for example at an interval, such that the OCR and OD model interpretations may be usable for an inquiry requiring a current interpretation of the video game.

Upon an indication of an advancement into a next mode, the agentic system model scheduler may determine which models should be used for the next mode. The next mode may not require data processing from the models used in the previous (e.g., initial) mode. The agentic system model scheduler may allocate GPU memory to the AI models needed for the next mode. In some embodiments, such memory allocation may include allocating previously unallocated GPU memory to at least some AI models from the next set and/or reallocating at least a portion of previously allocated GPU memory to at least some AI models from the next set (e.g., causing at least some of the AI models used in the initial mode to be replaced with one or more AI models from the next set). Each subsequent mode may go through a similar process. For example, the AI-powered virtual assistant for the video game may begin in a play mode. Upon detection of a request being submitted to the AI-powered virtual assistant by a player, the AI-powered virtual assistant may move from the play mode to the inquiry mode. The inquiry may be, for example, a voice request, a natural language input, and the like. During the inquiry mode, the AI-powered virtual assistant may not be collecting visual data using the OCR and OD models and may instead be recording the input to be interpreted. During the recording period, the agentic system model scheduler may cause GPU memory to be allocated to models which can be used to interpret the inquiry. Once the inquiry has finished, the AI-powered virtual assistant may advance from the inquiry mode to a processing mode. The processing mode may include interpreting the inquiry using models such as embedding models (EM), language models (LM), and the like. Once the processing is complete, the AI-powered virtual assistant may move from the processing mode to an answer mode where the answer is provided to the player using the next set of AI models. During each of the above mode transitions, the agentic system model scheduler can ensure that an appropriate portion of GPU memory is allocated to the AI models needed for the next mode.

Another example scheduling strategy referred to herein as a model-based strategy may include allocating GPU memory to AI models based on an order of AI models and an available GPU memory. As described above, not every AI model may be required to be on the GPU at all times for the agentic system. In some embodiments, AI models may be loaded onto the GPU based upon a need for the models to be used in data processing. GPU memory may be allocated to AI models according to a lock step method. A lock step method may be a method for identifying AI models and allocating GPU memory upon indication that the previous AI model has completed data processing. For example, a first model may be processing data on the GPU. Upon completion of the data processing, the first model may cause an indication of completion to be received at the agentic system model scheduler. The agentic system model scheduler may identify a next AI model to be allocated GPU memory.

Allocating GPU memory to AI models may be according to a pipeline method. A pipeline method may be a method for anticipatorily identifying AI models to the GPU and allocating GPU memory to the AI models upon indication of the completion of data processing of an AI model previously allocated GPU memory. For example, a first (e.g., initial) model may be processing data on the GPU. Upon identifying a next AI model that will be required to process the data once the initial model is done, the agentic system model scheduler may immediately allocate GPU memory for the next AI model upon indication of the data having been processed.

In some embodiments, each method or both methods may be used on one or more AI models on the GPU at the same time. The GPU may be able to fit multiple models simultaneously based on GPU memory capacity. As any one of the one or more models has finished processing the data, the agentic system model scheduler may reallocate to a next AI model at least a portion of memory previously allocated to the initial AI model(s).

Yet another example scheduling strategy referred to herein as an availability-based strategy may include allocating GPU memory to one or more AI models based on available GPU memory. As described above, not every AI model may be required to be on the GPU at all times for the agentic system. However, depending on AI model size, frequency of use of the AI model, or duration of use of the AI model, it may be beneficial to allow one or more AI models to remain on the GPU while other AI models may be allocated to, and replaced in, the GPU memory. While it may be preferable to allow an AI model to remain on the GPU, the memory utilized by the AI model maybe earmarked within the system to indicate that, should it become necessary, the GPU memory may be reallocated. If the GPU memory has been utilized for the alternative purpose, the AI model may be reallocated GPU memory by the agentic system model scheduler and may remain until another use becomes necessary. Each time the AI model is allocated GPU memory, the GPU memory occupied by the AI model may be earmarked for use in alternative circumstances.

Yet another example scheduling strategy referred to herein as a temporary requisition-based strategy may be utilized in a system in which a first portion of GPU memory is utilized for AI models, and a second portion of GPU memory is utilized for other purposes. For example, in the context of AI-powered virtual assistant for a video game, the second portion of the GPU may be utilized for supporting the game functionality. GPU memory within the second portion may not all be utilized at a particular time during operation of the video game. The agentic system model scheduler may temporarily requisition the unutilized GPU memory of the second portion at the particular time for an AI model. After completing the objective of the AI model, the GPU memory may be released by the agentic system model scheduler such that it is usable for the intended purpose. For example, within an AI-powered virtual assistant for a video game, the second portion at the second time may be available for an AI model temporarily and then released prior to the game functionality requiring the GPU memory.

Accordingly, aspects of the present disclosure enable efficient GPU usage to enable increasingly complex agentic systems to execute tasks within a limited GPU environment. Aspects of the present disclosure can enable transitions of AI models onto the GPU to process data, depending on available memory of the GPU and AI model utilizations. The agentic system model scheduler may monitor the available GPU memory to determine which models can be loaded onto the GPU. AI models may be added to the GPU, potentially replacing other AI models, based on a need for the AI model to process data. Allowing GPU memory to be allocated and reallocated to AI models can limit latency and can reduce GPU application crashes created by excessive GPU memory use.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as small language models (SLMs), large language models (LLMs), vision language models (VLMs), and multimodal language models (MMLMs) (which may process text, voice, image, and/or other data types to generate outputs in one or more formats), systems implemented at least partially using cloud computing resources, systems for performing generative AI operations, and/or other types of systems.

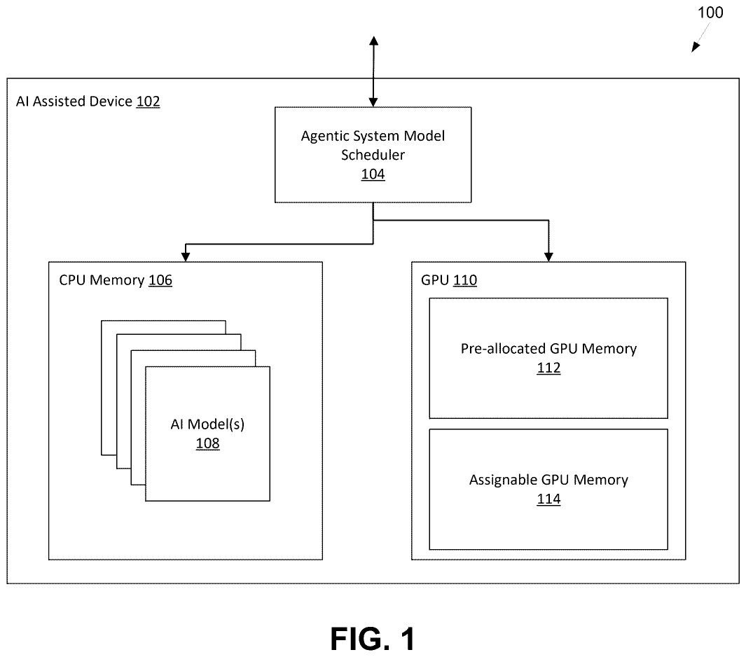

FIG. 1 is a schematic block diagram of an example system architecture 100 providing agentic system memory resource management, according to at least one embodiment. As depicted in FIG. 1, system architecture 100 may include an artificial intelligence (AI) assisted device 102 that can utilize memory resources of a graphical processing unit (GPU) 110 to support applications and agentic systems. An agentic system may be a system that includes multiple agents, such as agents using artificial intelligence (AI) models (e.g., computational models), acting independently to execute a single task. An agentic system may include, but is not limited to, one or more AI models 108 stored in the CPU memory 106 and an agentic system model scheduler 104 for allocating GPU 110 memory to the AI models 108 to enable AI model 108 task execution. Applications may be software systems that are programs or sets of instructions designed to perform specific tasks or functions for the user, such as word processing, data analysis, or gaming, on various devices or platforms. In some embodiments, task execution from agentic systems may be a secondary priority for an AI assisted device 102. Instead, maintaining and supporting the application may be a priority. For example, an AI assisted device 102 may be a gaming computer. The application running on the gaming computer may be the online video game application (referred to here as a “video game”) and the agentic system may be an AI-powered virtual assistant that can aid a player with gameplay. The priority for allocating the memory resources of the GPU 110 may be dedicated to supporting the video game rather than the AI-powered virtual assistant. In some embodiments, the GPU 110 may have a portion of memory resources, such as pre-allocated GPU memory 112, assigned to running the applications. In some embodiments, the GPU 110 may have a second portion of memory resources, such as assignable GPU memory 114, assignable for supporting agentic systems.

The agentic system may be implemented into an AI assisted device 102. In some embodiments, the agentic system may be an AI-powered virtual assistant that can be used with applications such as real-time interactive software, such as a video game. The AI assisted device 102 can include a central processing unit (CPU) memory 106 that can store one or more AI models 108 that can act as agents within the agentic system. In some embodiments, AI models 108 can be used together to accomplish a single task. For example, the AI-powered virtual assistant can use the AI models 108, together, to monitor the video game visuals, identify objects within the visuals, interpret a player request, generate a response to the player request using the identified objects and other data, and provide the response to the player. AI models 108 can be, for example, optical character recognition (OCR) models, object detection (OD) models, embedding models (EM), language models (LM), and the like.

The AI models 108 can be allocated memory resources from the GPU 110 to support task execution of the AI models 108. In some embodiments, GPU 110 memory resources are limited such that there are not enough memory resources to be allocated to all AI models 108 of the agentic system and the applications simultaneously. The agentic system model scheduler 104 can be used to monitor the memory resources of the GPU 110 to determine availability of assignable GPU memory 114 and/or pre-allocated GPU memory 112.

In some embodiments, the agentic system model scheduler 104 can be used to receive a task execution prompt from within the AI assisted device 102 or from external sources. For example, in an AI powered virtual assistant, the task execution prompt may be a request from a player to provide directions towards a next goal of the video game. Task execution caused by the prompt may include interpreting the prompt, reviewing data to generate a response to the prompt, and providing the response to the player. In some embodiments, the agentic model scheduler 104 may receive a task execution prompt from within the AI assisted device 102. For example, the application may identify a change in circumstances within the game, for example, changing from a menu visual to a game play visual, and may prompt the agentic system model scheduler 104 to begin visual identification using AI models 108.

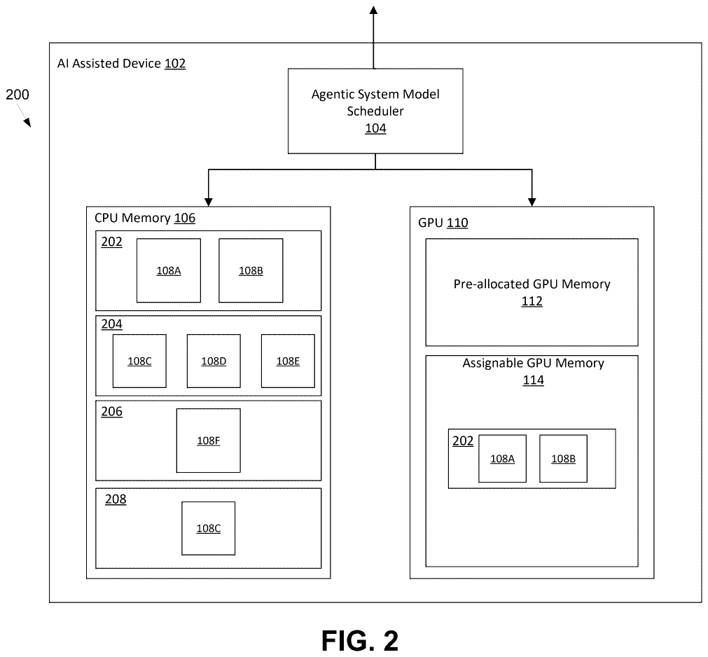

In some embodiments, each AI model of the AI models 108 may utilize a different amount of memory resources of the GPU 110. For example, an AI model 108 that is used to monitor and interpret visual data may require more GPU 110 memory than an AI model 108 that is used to identify related data of the application. Depending on the amount of memory resources required by each individual AI model 108 and by the collection of AI models 108 useable by the agentic system, the agentic system model scheduler 104 may be required to allocate and reallocate memory resources between one or more AI models 108 of the AI models 108 during task execution (e.g., in real time). FIGS. 2-6 show example strategies for utilizing the agentic system model scheduler 104 to allocate memory resources of the GPU 110 to AI models 108 stored within the CPU memory 106 for supporting task execution of the agentic system.

FIG. 2 illustrates an example mode-based strategy 200 for memory resource allocation using the agentic system memory resource management architecture 100 of FIG. 1, according to at least one embodiment. In some embodiments, the AI models 108 can be segmented for association with one or more modes. A mode can refer to operations that use a subset of the AI models 108 for task execution of an agentic system. The subset of the AI models 108 can be determined by grouping together AI models 108 that can be used simultaneously for a portion of task execution. For example, modes can be or otherwise include a mode that is collecting data, a mode that is interpreting requests, a mode that is generating a response, a mode that is providing the response, and the like. For example, within the context of an AI powered virtual assistant for a video game, modes may include a play mode, an inquiry mode, a processing mode, an answer mode, and the like. AI models 108 for each mode may be determined (e.g., dynamically) by the agentic system model scheduler 104 or may be pre-determined by the agentic system. In some embodiments, AI models 108 may be portioned for association with modes based, at least partially on memory resource requirements. Each mode may be limited to requiring fewer memory resources than are available for allocation in the assignable GPU memory 114.

As shown in FIG. 2, a first mode 202 may include a first AI model 108A and a second model 108B. The first mode 202 may be stored within the CPU memory 106 and may, upon direction of the agentic system model scheduler 104, be allocated memory resources of the assignable GPU memory 114. In some embodiments, the first mode 202 may be a passive mode that is processing data on the application within the pre-allocated GPU memory 112 but is not actively working on a task to execute. For example, within the context of an AI-powered virtual assistant for a video game, the AI models 108A-108B associated with the first mode 202 may be models tasked with recognizing visuals (visually represented content) of the video game application. This first mode 202 may then be called a game play mode in which a user of the AI assisted device 102 is playing the video game but is not prompting the agentic system for a task execution.

The first mode 202 may be allocated GPU 110 memory even prior to identification of a task to execute to enable the agentic system to be prepared for a task execution request even during the passive state. For example, in the context of an AI-powered virtual assistant, the first mode 202 may be monitoring actions taken by the user and visuals of the game, such as previously visited locations on a game map. Should a user request additional map locations to visit, the AI-powered virtual assistant already has data that indicates map locations already visited and can provide alternative map locations accurately.

In some embodiments, the agentic system model scheduler 104, can be provided an indication to advance to a next mode or can monitor resources within the AI assisted device 102 to identify an indication to advance to a next mode. For example, to transition from the first mode 202 to the second mode 204, the agentic system model scheduler 104 may receive identification of a request from a user or may identify a request from a user. For example, the user may be a player of a video game that prompts the AI assisted device 102. Upon receiving the prompt, agentic system model scheduler 104 may identify the second mode 204, such as an inquiry mode, to be allocated the assignable GPU memory 114. In some embodiments, the second mode 204 may include one or more AI models 108C-108E to process the inquiry. AI models 108C-108E can include, but are not limited to embedding models, language models, and the like usable for interpreting the inquiry provided in plain language into an inquiry usable for enabling task execution of the system.

In some embodiments, the assignable GPU memory 114 may not include sufficient memory resources to support both the first mode 202 and the second mode 204. In such embodiments, the agentic system model scheduler 104 may direct the memory allocated to the first mode 202 be reallocated to the second mode 204. In some embodiments, the memory allocated to the first mode 202 may be insufficient to support the second mode 204 and additional memory resources of the assignable GPU memory 114 may be allocated to the second mode 202 to support task execution of the AI models 108C-108E in the second mode.

In some embodiments, the assignable GPU memory 114 may include sufficient memory resources to support both the first mode 202 and the second mode 204. The agentic system model scheduler 104 may then identify unallocated memory resources of the assignable GPU memory 114 to be allocated to the second mode 204.

In some embodiments, the agentic system model scheduler 104 may not consider whether the assignable GPU memory 114 has enough unallocated memory during the first mode 202. In such embodiments, the agentic system model scheduler 104 will select a portion of the memory resources of the assignable GPU memory 114, allocated to the first mode 202 or unallocated, to be assigned to the second mode 204.

In some embodiments, the agentic system model scheduler 104 may monitor task execution of the AI models 108C-108E and may identify when the AI models 108C-108E have completed task execution. In some embodiments, the AI models 108C-108E may be configured to alert the agentic system model scheduler 104 upon completion of a task execution. Upon indication that all AI models 108C-108E within the second mode 204 have completed task execution, the agentic system model scheduler 104 may cause memory resources to be allocated to a third mode 206 according to the methods of memory allocation as described above. The third mode 206 may include one or more AI models 108 for completing a next portion of the task execution of the agentic system. Within the context of an AI-powered virtual assistant for a video game, for example, the third mode 206 may be a processing mode that uses the data collected in the first mode 202 and the prompt interpreted by the second mode 204 to identify a response to the prompt.

Once the third mode 206 is complete, the agentic system model scheduler 104 may allocate memory resources of the assignable GPU memory 114 to the fourth mode 208. A fourth mode 208 may use a shared AI model 108, for example AI model 108C that may be a language model. The fourth mode 208 may cause reallocation of memory to the AI model 108C to translate the response generated in the third mode 206 into plain language 208 for the user. For example, once a new location within the video game map is identified during the third mode 206, a language model may be used to generate directions for the user to navigate a character to the new location. Upon completion of the task, such as providing the response to the user, the agentic system model scheduler 104 may return the agentic system into a passive mode by reallocating the assignable GPU memory 114 to the AI models 108A-108B in the first mode 202 to collect data until another task is ready for execution.

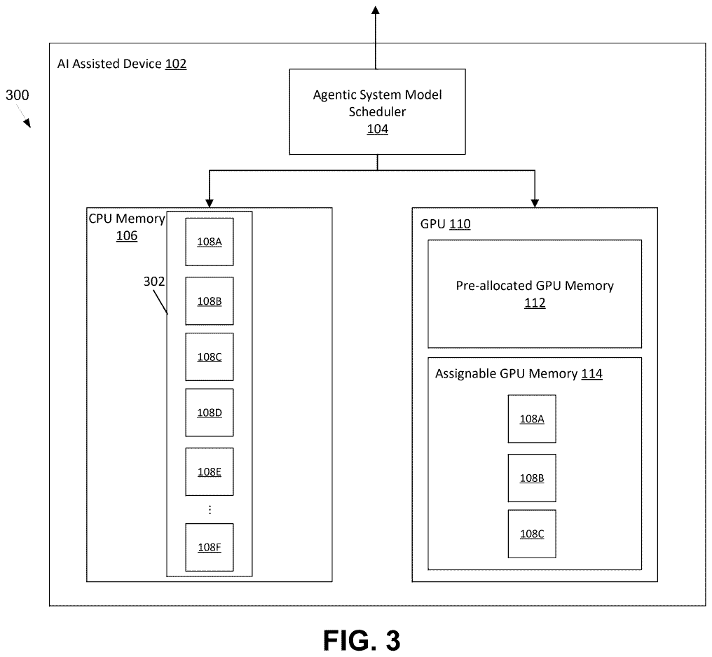

FIG. 3 illustrates an example model-based strategy 300 for memory resource allocation using the agentic system memory resource management architecture 100 of FIG. 1, according to at least one embodiment. In some embodiments, the AI models 108 can be usable by the agentic system for task execution in an order 302. The order 302 can be determined by identifying which AI model's 108 output is usable as an input for another AI model 108. For example, an output of an AI model classifying visuals of a video game may be used as an input for an AI model that determines a next action for a user based on previous user actions identifiable from the visuals of the video game. The order 302 can be determined based on a need of the agentic system during operation of the application. For example, when the application is running and the agentic system has not identified a prompt to cause response generation, the agentic system may require monitoring AI models to be allocated memory resources of the GPU 110. Upon receipt of a prompt, the agentic system may require the prompt be interpreted for other agentic system AI model use. Therefore, the order 302 may begin with AI models 108A-108C as monitoring AI models and AI model 108D as a large language model that, upon receipt of a prompt, may be allocated GPU 110 memory of the assignable GPU memory 114 to interpret the prompt. After interpretation of the prompt, the order 302 may continue with an AI model 108E being allocated GPU 110 memory of the assignable GPU memory 114 to generate a response to the prompt using the outputs from the monitoring AI models 108A-108C.

In some embodiments, the agentic system may have one or more AI models 108A-108C processing data during a passive phase of the agentic system process. Such AI models 108A-108C may be allocated memory resources according to standard rules for allocating all memory resources to AI models 108 or may be allocated resources differently. For example, the AI models 108A-108C may be allocated GPU 110 memory resources all at once and the memory resources may not be reallocated each time the AI models 108A-108C output data. Instead, memory resources allocated to the AI models 108A-108C may be reallocated upon an external event indication, for example, a prompt provided to the system.

In some embodiments, the agentic system model scheduler 104 may reallocate assignable GPU memory 114 using a lock step method. A lock step method may be a method for identifying AI models and allocating assignable GPU memory 114 upon indication that the previous AI model has completed data processing. For example, an AI model 108D may be processing data on the GPU 110. Upon completion of the data processing, the AI model 108D may cause an indication of completion to be received at the agentic system model scheduler 104. In such embodiments, the agentic system model scheduler 104 may identify the next model based on the order 302 or, using the output of the previous AI model 108, the agentic system model scheduler 104 may identify a next AI model 108E to be allocated assignable GPU memory 114. The agentic system model scheduler 104 can proceed to allocate memory to each AI model 108 in turn until the task execution is complete.

In some embodiments, the assignable GPU memory 114 may be sufficient to support multiple AI models 108 simultaneously. In such embodiments, the agentic system model scheduler 104 can still allocate GPU 110 memory to AI models 108 according to the order, but can allocate memory to as many AI models as are supportable and can monitor each for indication that the AI model 108 has finished data processing. After one of the models has finished data processing, the agentic system model scheduler 104 may re-allocate the memory previously allocated to the finished AI model 108 to the next AI model 108 and allow the models 108 that haven't finished their operations to continue processing. For example, upon receiving a prompt, the agentic system model scheduler 104 may determine the amount of assignable GPU memory 114 is available for allocation. The agentic system model scheduler 104 may review the memory requirements for the next AI model 108D in the order 302. After determining that the assignable GPU memory 114 can support the AI model 108D, the agentic system model scheduler 104 may review the memory requirements for the following AI models 108E-108F. The agentic system model scheduler 104 may determine that the first AI model 108D and a second AI model 108E can be supported by the assignable GPU memory 114 and may allocate the memory resources to the first and second AI models 108D and 108E. The agentic system model scheduler 104 may continue to monitor the first AI model 108D and the second AI model 108E and, upon determination that one of the AI models 108D-108E has completed execution, may identify a subsequent AI model 108 from the order to which the memory resources can be reallocated. The continual monitoring and reallocation of memory can enable the agentic system to execute tasks more efficiently as models are available to process data as soon as the data is available and without waiting for the next AI model 108 to be allocated memory resources.

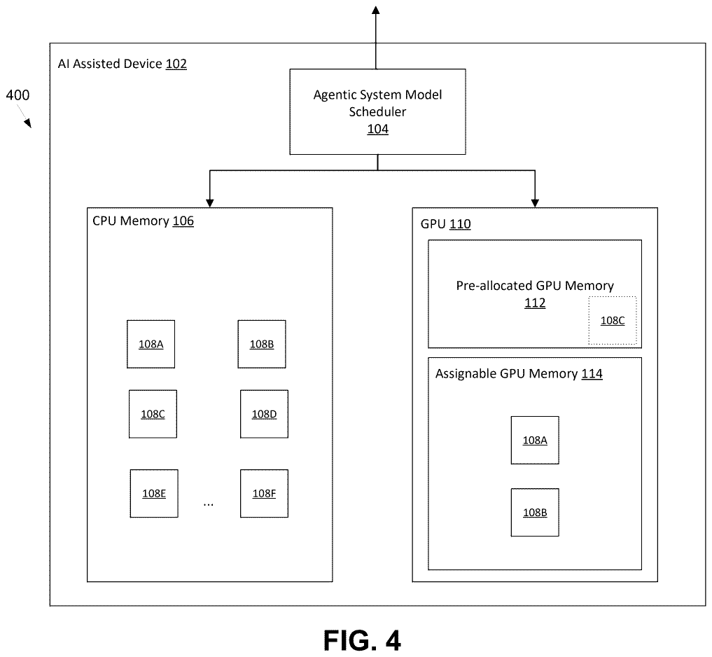

FIG. 4 illustrates an example temporary requisition-based strategy 400 for memory resource allocation using the agentic system memory resource management architecture 100 of FIG. 1, according to at least one embodiment. As described above, the AI models 108 used by an agentic system can be stored in CPU memory 106. As AI models 108 are required to process data to execute the task of the agentic system, the agentic system model scheduler 104 may allocate GPU 110 memory to the AI models 108 to enable the AI model 108 to process data. In some embodiments, the agentic system model scheduler 104 may only allocate assignable GPU memory 114 for agentic system task processing.

The pre-allocated GPU memory 112 may be assigned to executing one or more applications for the AI assisted device 102. For example, the AI assisted device 102 may be a gaming computer dedicated to executing applications that support gaming, such as a game engine. Depending on the game being played, the game engine may utilize more or less of the pre-allocated GPU memory 112. For example, a game with highly detailed visuals and complex physics may demand more GPU power than a game with simpler graphics. The agentic system model scheduler 104 may, upon determining an amount of pre-allocated GPU memory 112 resources being utilized, allocate pre-allocated GPU memory 112 to one or more AI models 108, for example, AI model 108C. Should the pre-allocated GPU memory 112 be required by the applications, the agentic system model scheduler 104 may release the borrowed GPU 110 memory resources back to the applications.

In some embodiments, applications may be utilizing a majority, or all, of the pre-allocated GPU memory 112 resources most of the time. There may be brief moments during operation in which the pre-allocated GPU memory 112 is not fully utilized. In some embodiments, the agentic system model scheduler 104 may be able to identify and/or predict the occurrence of the lull in pre-allocated GPU memory 112 resource usage and may allocate the unused memory resources to an AI model 108C. For example, in the context of an AI powered virtual assistant for a video game, the pre-allocated GPU memory 112 may be running applications to support the creation of video frames to be displayed to the player during gameplay. A video frame may be a single still image in a sequence that creates the illusion of motion. For example, a video game may include a character that the player can direct to run through a landscape. As the character runs, the applications may generate a sequence of video frames on the screen to depict the changing location. Video frame generation can, in some embodiments, require the application to draw each video game before it is presented. In some embodiments, certain applications may instead utilize machine learning and artificial intelligence technologies to generate some of the video frames. For example, the application may draw a first video frame and, based off the first video frame, generate the next two video frames in the sequence. Generating the video frames rather than drawing the video frames may require fewer pre-allocated GPU memory 112 resources. During the video frame generation, the agentic system model scheduler 104 may reallocate the pre-allocated GPU memory 112 resources that are available due to the generation of video frames to an AI model 108C. When the application attempts to draw the next video frame, the agentic system model scheduler 104 may release the memory resources that should be reallocated to the application.

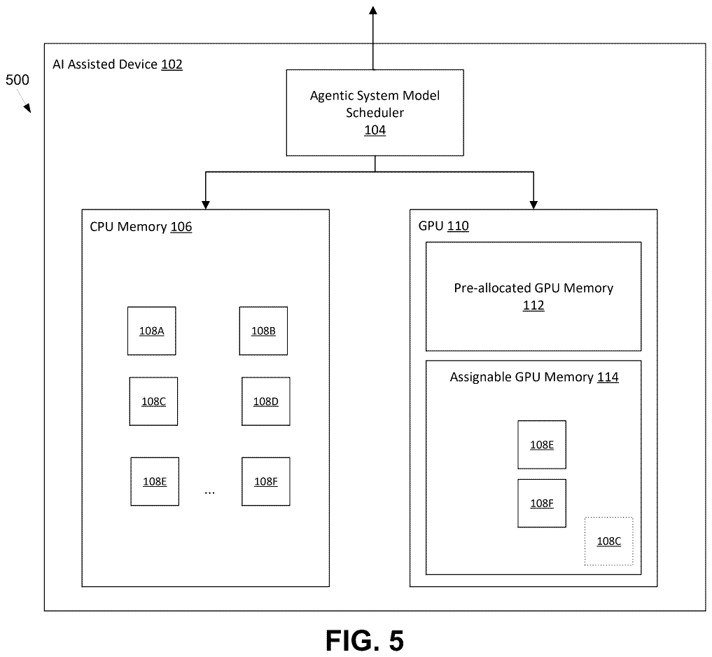

FIG. 5 illustrates an example availability-based strategy 500 for memory resource allocation using the agentic system memory resource management architecture 100 of FIG. 1, according to at least one embodiment. As described above, the AI models 108 used by an agentic system can be stored in CPU memory 106. As AI models 108 are required to process data to execute the task of the agentic system, the agentic system model scheduler 104 may allocate GPU 110 memory to the AI models 108 to enable the AI model 108 to process data. In some embodiments, efficiency of the agentic system can be further improved by identifying an AI model 108C that, if allowed to maintain the allocated assignable GPU memory 114, may decrease the response time for the agentic system.

In some embodiments, one or more models utilized by the agentic system may be utilized during more than one time during task execution. For example, in the context of an AI powered virtual assistant, a player of a video game may prompt the agentic system using plain language. The agentic system may utilize a large language model to interpret the prompt. After generating a response, the agentic system may utilize the large language model to provide a plain language response to the player. During task execution, the agentic system may require additional information from the player and may utilize the large language model to prompt the player to provide additional information and interpret the additional information for use. Rather than allocate and reallocate GPU 110 memory resources to the AI model 108C, allowing the AI model 108C to retain the resources can decrease the time required to allocate memory resources for an AI model 108C used frequently.

In some embodiments, the memory resources of the assignable GPU memory 114 may be limited. An AI model 108C retaining the memory resources can lessen the assignable GPU memory 114 that is available for other AI models 108. In some embodiments, one or more AI models 108 may require more memory resources than are available. The agentic system model scheduler 104 may note the memory resources that have been allocated to the AI model 108C intended to retain the memory resources and may reallocate the memory resources should it become necessary. After the one or more AI models 108 that were reallocated the memory resources previously allocated to the AI model 108 have completed data processing, the agentic system model scheduler 104 may reallocate the memory resources to the AI model 108C and note the memory resources as being available for reallocation upon necessity.

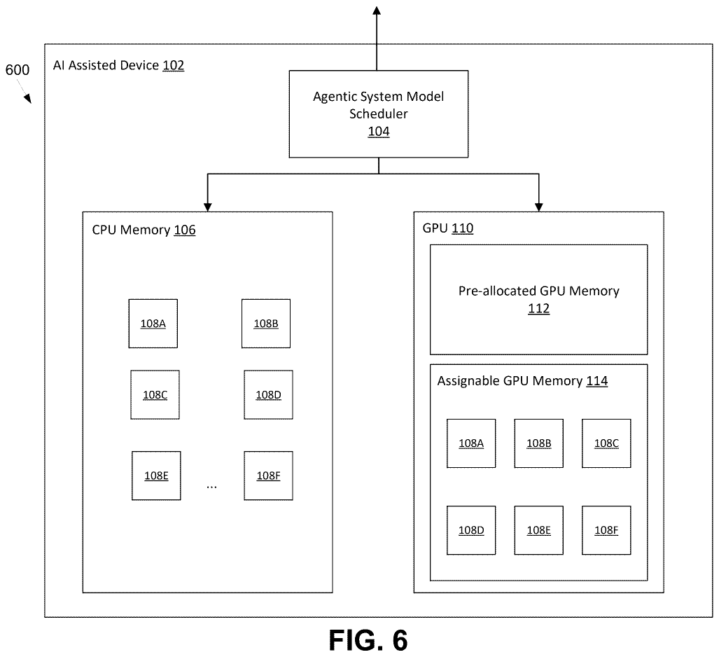

FIG. 6 illustrates an example full utilization strategy 600 for memory resource allocation using the agentic system memory resource management architecture 100 of FIG. 1, according to at least one embodiment. As described above, the AI models 108 used by an agentic system can be ordered according to an order 302 and stored in CPU memory 106. As AI models 108 are required to process data to execute the task of the agentic system, the agentic system model scheduler 104 may allocate GPU 110 memory to the AI models 108 to enable the AI model 108 to process data. In some embodiments, the agentic system model scheduler 104 may determine that the assignable GPU memory 114 is sufficient to support all AI models 108 for the agentic system. In some embodiments, the determination may occur periodically, for instance upon boot of the AI assisted device 102, launch of an application, prompts available for the agentic system and the like. Depending on the memory resources of the GPU 112 that are pre-allocated GPU memory 112 resources and the memory resources of the GPU 110 that are assignable GPU memory 114 resources, the agentic system model scheduler 104 may determine that all AI models 108 for the agentic system may be allocated memory resources.

For example, in the context of an AI powered assistant for a video game, a more complex video game may require more complex analysis than another and not all the same AI models 108 may be required. Upon determining that a video game being played will not require all AI models 108, the agentic system model scheduler 104 may determine that the assignable GPU memory 114 resources are sufficient to allocate to the AI models 108 that are required for the video game and may allocate memory to all of them.

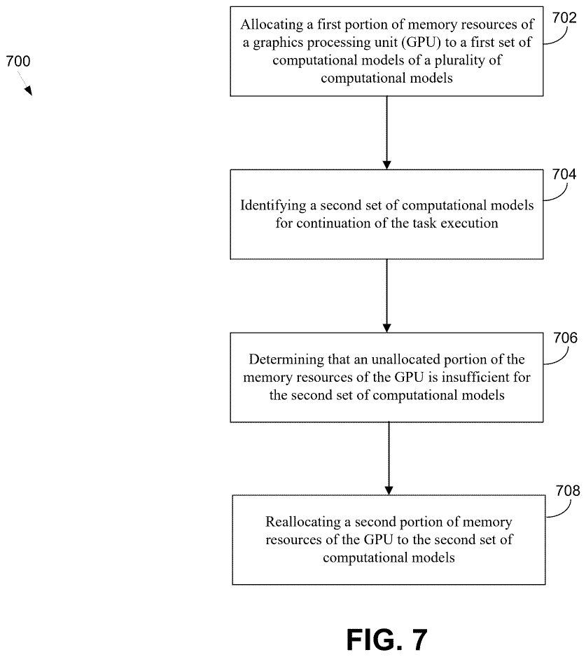

FIG. 7 is a flow diagram of an example method 700 of agentic system memory resource management, according to at least one embodiment. The method begins at block 702 with allocating, at a first point in time during a task execution, a first portion of memory resources of a graphics processing unit (GPU) to a first set of computational models of a plurality of computational models, wherein the first set of computational models requires an amount of memory resources less than the first portion of memory resources. As described above in FIGS. 1-6, a first portion of memory resources such as the assignable GPU memory 114 resources may be assigned to computational models such as AI models 108. In some embodiments, the first portion of memory resources is committed to task execution using computational models. In some embodiments, the first point in time may be upon boot up of the AI assisted device 102, identification of an agentic system model scheduler 104, receipt of a prompt from a user of the AI assisted device 102, and the like.

The method continues at block 704. The agentic system can identify, at a second point in time during the task execution, a second set of computational models for continuation of the task execution. As described above, the second point in time may be upon detection of the completion of data processing from a computational model previously allocated memory resources, may be upon allocation of memory resources to the first set of computational modes, and/or may be upon receipt of an external prompt. In some embodiments, the agentic system model scheduler 104 may identify a memory resource requirement for each computational model of the plurality of computational models and select one or more computational models for the second set of computational models based on the amount of memory resources of the first portion.

The method continues at block 706. The agentic system can determine that a second portion of the memory resources of the GPU is insufficient for the second set of computational models. In some embodiments, the second portion can be an unallocated portion of memory resources of the GPU.

The method continues at block 708. The agentic system can reallocate a third portion of memory resources of the GPU to the second set of computational models. In some embodiments, the first portion of resources and the third portion of resources may be the same GPU 110 memory resources. In some embodiments, the first portion of resources and the third portion of resources may include common GPU 110 memory resources, such that the third portion of resources may be include a sub-portion of the first portion of memory resources. In some embodiments, the first portion of resources and the third portion of resources may not share any GPU 110 memory resources. In some embodiments, the third portion of memory resources is committed to executing a GPU 110 application.

In some embodiments, the agentic system may further identify the third portion of memory resources, by identifying GPU 110 memory resources that are committed to executing the GPU 110 that are idle. The agentic system may allocate the third portion of memory resources to the second set of computational models and execute the computation models. Following execution of the computational models, the agentic system (e.g., the agentic system model scheduler 104) may deallocate the third portion of memory resources from the second set of computational models.

In some embodiments, the agentic system (e.g., the agentic system model scheduler 104) may reallocate the memory resources by replacing the first set of computational models with the one or more of the second set of computational models in the third portion of memory resources. In some embodiments, the agentic system model scheduler 104 may identify a computational model of the first set of computational models to maintain in a first sub-portion of the first portion of memory resources. Based on the memory resources of the first portion of the memory resources and the first sub-portion of memory resources, the agentic system model scheduler 104 may determine that a second sub-portion of the first portion of memory resources is sufficient for the second set of computational models. The memory resources of the second sub-portion of the first portion may be reallocated to the second set of computational models.

In some embodiments, the agentic system may further identify one or more modes as discussed above in FIG. 2. Based on the one or more modes, the agentic system (e.g., the agentic system model scheduler 104) may identify one or more computational models for the first set of computational models and the second set of computational models from the plurality of computational models associated with each mode of the one or more modes, wherein the memory resources utilized by the first set of computational models and the second set of computational models are less than available memory resources of the GPU.

### Inference and Training Logic

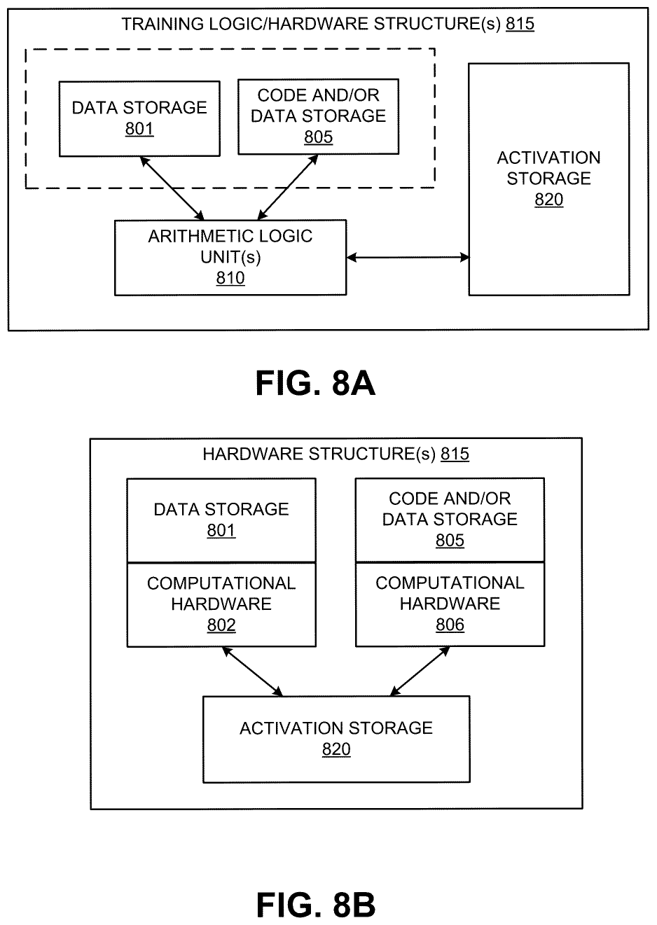

FIG. 8A illustrates inference and/or training logic 815 used to perform inferencing and/or training operations associated with one or more embodiments.

In at least one embodiment, inference and/or training logic 815 may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, training logic 815 may include, or be coupled to code and/or data storage 801 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or code and/or data storage 801 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 801 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 815 may include, or be coupled to code and/or data storage 805 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to one or more processors or other hardware logic devices or circuits. In at least one embodiment, code and/or data storage 805 may be cache memory, DRAM, SRAM, non-volatile memory (e.g., flash memory), or other storage. In at least one embodiment, a choice of whether code and/or data storage 805 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be a combined storage structure. In at least one embodiment, code and/or data storage 801 and code and/or data storage 805 may be partially combined and partially separate. In at least one embodiment, any portion of code and/or data storage 801 and code and/or data storage 805 may be included with other on-chip or off-chip data storage, including a processor's L1, L2, or L3 cache or system memory.

In at least one embodiment, inference and/or training logic 815 may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a coprocessor). In at least one embodiment, ALU(s) 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., flash memory), or other storage. In at least one embodiment, activation storage 820 may be completely or partially within or external to one or more processors or other logical circuits. In at least one embodiment, a choice of whether activation storage 820 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 815 illustrated in FIG. 8A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8A may be used in conjunction with central processing unit (“CPU”) hardware, graphics processing unit (“GPU”) hardware or other hardware, such as field programmable gate arrays (“FPGAs”).

FIG. 8B illustrates inference and/or training logic 815, according to at least one embodiment. In at least one embodiment, inference and/or training logic 815 may include, without limitation, hardware logic in which computational resources are dedicated or otherwise exclusively used in conjunction with weight values or other information corresponding to one or more layers of neurons within a neural network. In at least one embodiment, inference and/or training logic 815 illustrated in FIG. 8B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 815 illustrated in FIG. 8B may be used in conjunction with central processing unit (CPU) hardware, graphics processing unit (GPU) hardware or other hardware, such as field programmable gate arrays (FPGAs). In at least one embodiment, inference and/or training logic 815 includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 comprises one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one storage/computational pair 801/802 of code and/or data storage 801 and computational hardware 802 is provided as an input to a next storage/computational pair 805/806 of code and/or data storage 805 and computational hardware 806, in order to mirror a conceptual organization of a neural network. In at least one embodiment, each of storage/computational pairs 801/802 and 805/806 may correspond to more than one neural network layer. In at least one embodiment, additional storage/computation pairs (not shown) subsequent to or in parallel with storage/computation pairs 801/802 and 805/806 may be included in inference and/or training logic 815.

### Neural Network Training and Deployment

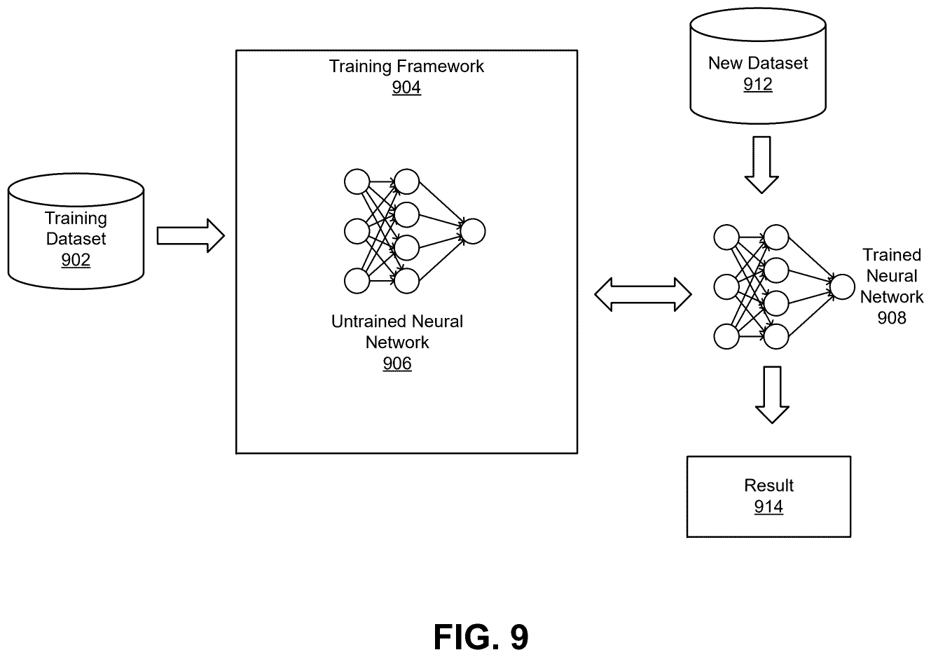

FIG. 9 illustrates training and deployment of a deep neural network, according to at least one embodiment. In at least one embodiment, untrained neural network 906 is trained using a training dataset 902. In at least one embodiment, training framework 904 is a PyTorch framework, whereas in other embodiments, training framework 904 is a TensorFlow, Boost, Caffe, Microsoft Cognitive Toolkit/CNTK, MXNet, Chainer, Keras, Deeplearning4j, or other training framework. In at least one embodiment, training framework 904 trains an untrained neural network 906 and enables it to be trained using processing resources described herein to generate a trained neural network 908. In at least one embodiment, weights may be chosen randomly or by pre-training using a deep belief network. In at least one embodiment, training may be performed in either a supervised, partially supervised, or unsupervised manner.

In at least one embodiment, untrained neural network 906 is trained using supervised learning, wherein training dataset 902 includes an input paired with a desired output for an input, or where training dataset 902 includes input having a known output and an output of neural network 906 is manually graded. In at least one embodiment, untrained neural network 906 is trained in a supervised manner and processes inputs from training dataset 902 and compares resulting outputs against a set of expected or desired outputs. In at least one embodiment, errors are then propagated back through untrained neural network 906. In at least one embodiment, training framework 904 adjusts weights that control untrained neural network 906. In at least one embodiment, training framework 904 includes tools to monitor how well untrained neural network 906 is converging towards a model, such as trained neural network 908, suitable to generating correct answers, such as in result 914, based on input data such as a new dataset 912. In at least one embodiment, training framework 904 trains untrained neural network 906 repeatedly while adjusting weights to refine an output of untrained neural network 906 using a loss function and adjustment algorithm, such as stochastic gradient descent. In at least one embodiment, training framework 904 trains untrained neural network 906 until untrained neural network 906 achieves a desired accuracy. In at least one embodiment, trained neural network 908 can then be deployed to implement any number of machine learning operations.

In at least one embodiment, untrained neural network 906 is trained using unsupervised learning, whereas untrained neural network 906 attempts to train itself using unlabeled data. In at least one embodiment, unsupervised learning training dataset 902 will include input data without any associated output data or “ground truth” data. In at least one embodiment, untrained neural network 906 can learn groupings within training dataset 902 and can determine how individual inputs are related to untrained dataset 902. In at least one embodiment, unsupervised training can be used to generate a self-organizing map in trained neural network 908 capable of performing operations useful in reducing dimensionality of new dataset 912. In at least one embodiment, unsupervised training can also be used to perform anomaly detection, which allows identification of data points in new dataset 912 that deviate from normal patterns of new dataset 912.

In at least one embodiment, semi-supervised learning may be used, which is a technique in which in training dataset 902 includes a mix of labeled and unlabeled data. In at least one embodiment, training framework 904 may be used to perform incremental learning, such as through transferred learning techniques. In at least one embodiment, incremental learning enables trained neural network 908 to adapt to new dataset 912 without forgetting knowledge instilled within trained neural network 908 during initial training.

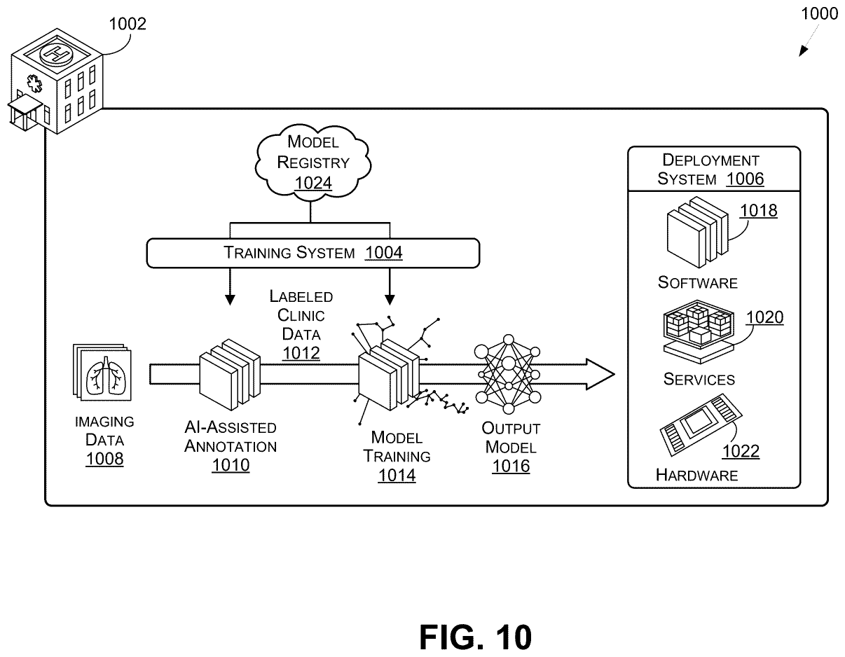

With reference to FIG. 10, FIG. 10 is an example data flow diagram for a process 1000 of generating and deploying a processing and inferencing pipeline, according to at least one embodiment. In at least one embodiment, process 1000 may be deployed to perform game name recognition analysis and inferencing on user feedback data at one or more facilities 1002, such as a data center.

In at least one embodiment, process 1000 may be executed within a training system 1004 and/or a deployment system 1006. In at least one embodiment, training system 1004 may be used to perform training, deployment, and embodiment of machine learning models (e.g., neural networks, object detection algorithms, computer vision algorithms, etc.) for use in deployment system 1006. In at least one embodiment, deployment system 1006 may be configured to offload processing and compute resources among a distributed computing environment to reduce infrastructure requirements at facility 1002. In at least one embodiment, deployment system 1006 may provide a streamlined platform for selecting, customizing, and implementing virtual instruments for use with computing devices at facility 1002. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 1006 during execution of applications.

In at least one embodiment, some applications used in advanced processing and inferencing pipelines may use machine learning models or other AI to perform one or more processing steps. In at least one embodiment, machine learning models may be trained at facility 1002 using feedback data 1008 (such as imaging data) stored at facility 1002 or feedback data 1008 from another facility or facilities, or a combination thereof. In at least one embodiment, training system 1004 may be used to provide applications, services, and/or other resources for generating working, deployable machine learning models for deployment system 1006.

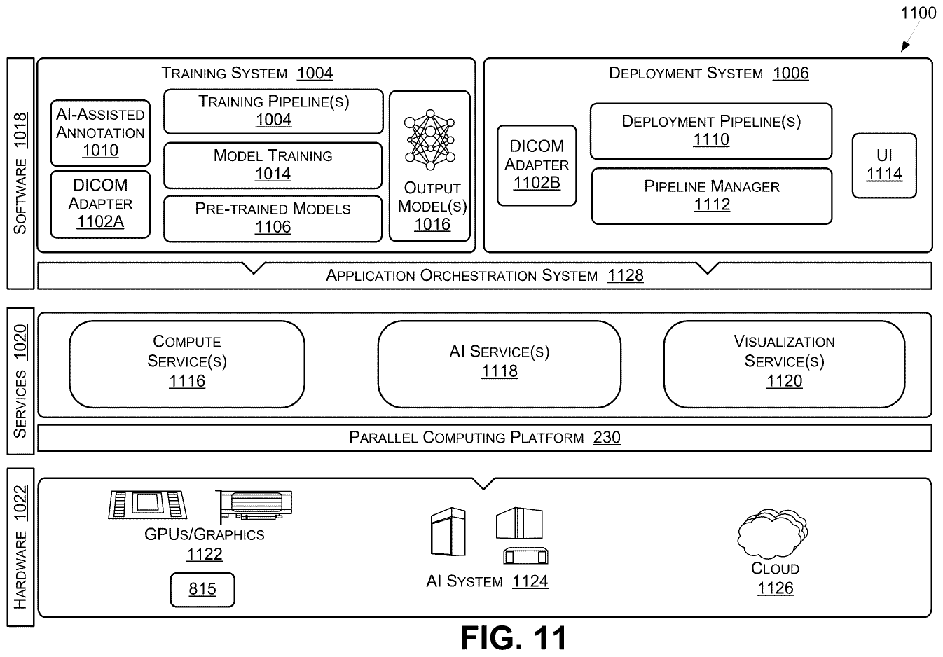

In at least one embodiment, a model registry 1124 may be backed by object storage that may support versioning and object metadata. In at least one embodiment, object storage may be accessible through, for example, a cloud storage (e.g., a cloud 1126 of FIG. 11) compatible application programming interface (API) from within a cloud platform. In at least one embodiment, machine learning models within model registry 1124 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 904 (FIG. 11) may include a scenario where facility 1002 is training their own machine learning model, or has an existing machine learning model that needs to be optimized or updated. In at least one embodiment, feedback data 1008 may be received from various channels, such as forums, web forms, or the like. In at least one embodiment, once feedback data 1008 is received, AI-assisted annotation 1010 may be used to aid in generating annotations corresponding to feedback data 1008 to be used as ground truth data for a machine learning model. In at least one embodiment, AI-assisted annotation 1010 may include one or more machine learning models (e.g., convolutional neural networks (CNNs)) that may be trained to generate annotations corresponding to certain types of feedback data 1008 (e.g., from certain devices) and/or certain types of anomalies in feedback data 1008. In at least one embodiment, AI-assisted annotations 1010 may then be used directly, or may be adjusted or fine-tuned using an annotation tool, to generate ground truth data. In at least one embodiment, in some examples, labeled data 1012 may be used as ground truth data for training a machine learning model. In at least one embodiment, AI-assisted annotations 1010, labeled data 1012, or a combination thereof may be used as ground truth data for training a machine learning model, e.g., via model training 1014 in FIGS. 9-10. In at least one embodiment, a trained machine learning model may be referred to as an output model 1016, and may be used by deployment system 1006, as described herein.

In at least one embodiment, training pipeline 904 (FIG. 11) may include a scenario where facility 1002 needs a machine learning model for use in performing one or more processing tasks for one or more applications in deployment system 1006, but facility 1002 may not currently have such a machine learning model (or may not have a model that is optimized, efficient, or effective for such purposes). In at least one embodiment, an existing machine learning model may be selected from model registry 1124. In at least one embodiment, model registry 1124 may include machine learning models trained to perform a variety of different inference tasks on imaging data. In at least one embodiment, machine learning models in model registry 1124 may have been trained on imaging data from different facilities than facility 1002 (e.g., facilities that are remotely located). In at least one embodiment, machine learning models may have been trained on imaging data from one location, two locations, or any number of locations. In at least one embodiment, when being trained on imaging data, which may be a form of feedback data 1008, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 1124. In at least one embodiment, a machine learning model may then be retrained, or updated, at any number of other facilities, and a retrained or updated model may be made available in model registry 1124. In at least one embodiment, a machine learning model may then be selected from model registry 1124—and referred to as output model 1016—and may be used in deployment system 1006 to perform one or more processing tasks for one or more applications of a deployment system.

In at least one embodiment, training pipeline 904 (FIG. 11) may be used in a scenario that includes facility 1002 requiring a machine learning model for use in performing one or more processing tasks for one or more applications in deployment system 1006, but facility 1002 may not currently have such a machine learning model (or may not have a model that is optimized, efficient, or effective for such purposes). In at least one embodiment, a machine learning model selected from model registry 1124 might not be fine-tuned or optimized for feedback data 1008 generated at facility 1002 because of differences in populations, genetic variations, robustness of training data used to train a machine learning model, diversity in anomalies of training data, and/or other issues with training data. In at least one embodiment, AI-assisted annotation 1010 may be used to aid in generating annotations corresponding to feedback data 1008 to be used as ground truth data for retraining or updating a machine learning model. In at least one embodiment, labeled data 1012 may be used as ground truth data for training a machine learning model. In at least one embodiment, retraining or updating a machine learning model may be referred to as model training 1014. In at least one embodiment, model training 1014—e.g., AI-assisted annotations 1010, labeled data 1012, or a combination thereof—may be used as ground truth data for retraining or updating a machine learning model.

In at least one embodiment, deployment system 1006 may include software 1018, services 1020, hardware 1022, and/or other components, features, and functionality. In at least one embodiment, deployment system 1006 may include a software “stack,” such that software 1018 may be built on top of services 1020 and may use services 1020 to perform some or all of processing tasks, and services 1020 and software 1018 may be built on top of hardware 1022 and use hardware 1022 to execute processing, storage, and/or other compute tasks of deployment system 1006.

In at least one embodiment, software 1018 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 1008 (or other data types, such as those described herein). In at least one embodiment, an advanced processing and inferencing pipeline may be defined based on selections of different containers that are desired or required for processing feedback data 1008, in addition to containers that receive and configure imaging data for use by each container and/or for use by facility 1002 after processing through a pipeline (e.g., to convert outputs back to a usable data type for storage and display at facility 1002). In at least one embodiment, a combination of containers within software 1018 (e.g., that make up a pipeline) may be referred to as a virtual instrument (as described in more detail herein), and a virtual instrument may leverage services 1020 and hardware 1022 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1016 of training system 1004.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1124 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1020 as a system (e.g., system 1100 of FIG. 11). In at least one embodiment, once validated by system 1100 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1100 of FIG. 11). In at least one embodiment, completed and validated applications or containers may be stored in a container registry and associated machine learning models may be stored in model registry 1124. In at least one embodiment, a requesting entity that provides an inference or image processing request may browse a container registry and/or model registry 1124 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 1006 (e.g., a cloud) to perform processing of a data processing pipeline. In at least one embodiment, processing by deployment system 1006 may include referencing selected elements (e.g., applications, containers, models, etc.) from a container registry and/or model registry 1124. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1020 may be leveraged. In at least one embodiment, services 1020 may include compute services, collaborative content creation services, simulation services, artificial intelligence (AI) services, visualization services, and/or other service types. In at least one embodiment, services 1020 may provide functionality that is common to one or more applications in software 1018, so functionality may be abstracted to a service that may be called upon or leveraged by applications. In at least one embodiment, functionality provided by services 1020 may run dynamically and more efficiently, while also scaling well by allowing applications to process data in parallel, e.g., using a parallel computing platform 1230 (FIG. 11). In at least one embodiment, rather than each application that shares a same functionality offered by a service 1020 being required to have a respective instance of service 1020, service 1020 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 1020 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1018 implementing advanced processing and inferencing pipeline may be streamlined because each application may call upon the same inference service to perform one or more inferencing tasks.

In at least one embodiment, hardware 1022 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 1022 may be used to provide efficient, purpose-built support for software 1018 and services 1020 in deployment system 1006. In at least one embodiment, use of GPU processing may be implemented for processing locally (e.g., at facility 1002), within an AI/deep learning system, in a cloud system, and/or in other processing components of deployment system 1006 to improve efficiency, accuracy, and efficacy of game name recognition.

In at least one embodiment, software 1018 and/or services 1020 may be optimized for GPU processing with respect to deep learning, machine learning, and/or high-performance computing, simulation, and visual computing, as non-limiting examples. In at least one embodiment, at least some of the computing environment of deployment system 1006 and/or training system 1004 may be executed in a datacenter or one or more supercomputers or high performance computing systems, with GPU-optimized software (e.g., hardware and software combination of NVIDIA's DGX™ system). In at least one embodiment, hardware 1022 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 11 is a system diagram for an example system 1100 for generating and deploying a deployment pipeline, according to at least one embodiment. In at least one embodiment, system 1100 may be used to implement process 1000 of FIG. 9 and/or other processes including advanced processing and inferencing pipelines. In at least one embodiment, system 1100 may include training system 1004 and deployment system 1006. In at least one embodiment, training system 1004 and deployment system 1006 may be implemented using software 1018, services 1020, and/or hardware 1022, as described herein.

In at least one embodiment, system 1100 (e.g., training system 1004 and/or deployment system 1006) may implemented in a cloud computing environment (e.g., using cloud 1126). In at least one embodiment, system 1100 may be implemented locally with respect to a facility, or as a combination of both cloud and local computing resources. In at least one embodiment, access to APIs in cloud 1126 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1100, may be restricted to a set of public internet service providers (ISPs) that have been vetted or authorized for interaction.

In at least one embodiment, various components of system 1100 may communicate between and among one another using any of a variety of different network types, including but not limited to local area networks (LANs) and/or wide area networks (WANs) via wired and/or wireless communication protocols. In at least one embodiment, communication between facilities and components of system 1100 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 1004 may execute training pipelines 904, similar to those described herein with respect to FIG. 9. In at least one embodiment, where one or more machine learning models are to be used in deployment pipelines 1110 by deployment system 1006, training pipelines 904 may be used to train or retrain one or more (e.g., pre-trained) models, and/or implement one or more of pre-trained models 1206 (e.g., without a need for retraining or updating). In at least one embodiment, as a result of training pipelines 904, output model(s) 1016 may be generated. In at least one embodiment, training pipelines 904 may include any number of processing steps, AI-assisted annotation 1010, labeling or annotating of feedback data 1008 to generate labeled data 1012, model selection from a model registry, model training 1014, training, retraining, or updating models, and/or other processing steps. In at least one embodiment, for different machine learning models used by deployment system 1006, different training pipelines 904 may be used. In at least one embodiment, training pipeline 904, similar to a first example described with respect to FIG. 9, may be used for a first machine learning model, training pipeline 904, similar to a second example described with respect to FIG. 9, may be used for a second machine learning model, and training pipeline 904, similar to a third example described with respect to FIG. 9, may be used for a third machine learning model. In at least one embodiment, any combination of tasks within training system 1004 may be used depending on what is required for each respective machine learning model. In at least one embodiment, one or more of machine learning models may already be trained and ready for deployment so machine learning models may not undergo any processing by training system 1004, and may be implemented by deployment system 1006.

In at least one embodiment, output model(s) 1016 and/or pre-trained model(s) 1206 may include any types of machine learning models depending on embodiment. In at least one embodiment, and without limitation, machine learning models used by system 1100 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 904 may include AI-assisted annotation. In at least one embodiment, labeled data 1012 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 1008 (or other data type used by machine learning models), there may be corresponding ground truth data generated by training system 1004. In at least one embodiment, AI-assisted annotation may be performed as part of deployment pipelines 1110; either in addition to, or in lieu of, AI-assisted annotation included in training pipelines 904. In at least one embodiment, system 1100 may include a multi-layer platform that may include a software layer (e.g., software 1018) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 1002. In at least one embodiment, applications may then call or execute one or more services 1020 for performing compute, AI, or visualization tasks associated with respective applications, and software 1018 and/or services 1020 may leverage hardware 1022 to perform processing tasks in an effective and efficient manner.

In at least one embodiment, deployment system 1006 may execute deployment pipelines 1110. In at least one embodiment, deployment pipelines 1110 may include any number of applications that may be sequentially, non-sequentially, or otherwise applied to feedback data (and/or other data types), including AI-assisted annotation, as described above. In at least one embodiment, as described herein, a deployment pipeline 1110 for an individual device may be referred to as a virtual instrument for a device. In at least one embodiment, for a single device, there may be more than one deployment pipeline 1110 depending on information desired from data generated by a device.

In at least one embodiment, applications available for deployment pipelines 1110 may include any application that may be used for performing processing tasks on feedback data or other data from devices. In at least one embodiment, because various applications may share common image operations, in some embodiments, a data augmentation library (e.g., as one of services 1020) may be used to accelerate these operations. In at least one embodiment, to avoid bottlenecks of conventional processing approaches that rely on CPU processing, parallel computing platform 1230 may be used for GPU acceleration of these processing tasks.

In at least one embodiment, deployment system 1006 may include a user interface (UI) 1114 (e.g., a graphical user interface, a web interface, etc.) that may be used to select applications for inclusion in deployment pipeline(s) 1110, arrange applications, modify or change applications or parameters or constructs thereof, use and interact with deployment pipeline(s) 1110 during set-up and/or deployment, and/or to otherwise interact with deployment system 1006. In at least one embodiment, although not illustrated with respect to training system 1004, UI 1114 (or a different user interface) may be used for selecting models for use in deployment system 1006, for selecting models for training, or retraining, in training system 1004, and/or for otherwise interacting with training system 1004. In at least one embodiment, training system 1004 and deployment system 1006 may include DICOM adapters 1102A and 1102B.

In at least one embodiment, pipeline manager 1112 may be used, in addition to an application orchestration system 1028, to manage interaction between applications or containers of deployment pipeline(s) 1110 and services 1020 and/or hardware 1022. In at least one embodiment, pipeline manager 1112 may be configured to facilitate interactions from application to application, from application to service 1020, and/or from application or service to hardware 1022. In at least one embodiment, although illustrated as included in software 1018, this is not intended to be limiting, and in some examples pipeline manager 1112 may be included in services 1020. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1110 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1112 and application orchestration system 1028. In at least one embodiment, so long as an expected input and/or output of each container or application is known by a system (e.g., based on constructs of applications or containers), application orchestration system 1028 and/or pipeline manager 1112 may facilitate communication among and between, and sharing of resources among and between, each of applications or containers. In at least one embodiment, because one or more of applications or containers in deployment pipeline(s) 1110 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1020 leveraged and shared by applications or containers in deployment system 1006 may include compute services 1116, collaborative content creation services 1217, AI services 1118, simulation services 1219, visualization services 1120, and/or other service types. In at least one embodiment, applications may call (e.g., execute) one or more of services 1020 to perform processing operations for an application. In at least one embodiment, compute services 1116 may be leveraged by applications to perform super-computing or other high-performance computing (HPC) tasks. In at least one embodiment, compute service(s) 1116 may be leveraged to perform parallel processing (e.g., using a parallel computing platform 1230) for processing data through one or more of applications and/or one or more tasks of a single application, substantially simultaneously. In at least one embodiment, parallel computing platform 1230 (e.g., NVIDIA's CUDA®) may enable general purpose computing on GPUs (GPGPU) (e.g., GPUs 1122). In at least one embodiment, a software layer of parallel computing platform 1230 may provide access to virtual instruction sets and parallel computational elements of GPUs, for execution of compute kernels. In at least one embodiment, parallel computing platform 1230 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1230 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1118 may be leveraged to perform inferencing services for executing machine learning model(s) associated with applications (e.g., tasked with performing one or more processing tasks of an application). In at least one embodiment, AI services 1118 may leverage AI system 1124 to execute machine learning model(s) (e.g., neural networks, such as CNNs) for segmentation, reconstruction, object detection, feature detection, classification, and/or other inferencing tasks. In at least one embodiment, applications of deployment pipeline(s) 1110 may use one or more of output models 1016 from training system 1004 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 1020 and/or hardware 1022) based on priority paths for different inferencing tasks of AI services 1118.

In at least one embodiment, shared storage may be mounted to AI services 1118 within system 1100. In at least one embodiment, shared storage may operate as a cache (or other storage device type) and may be used to process inference requests from applications. In at least one embodiment, when an inference request is submitted, a request may be received by a set of API instances of deployment system 1006, and one or more instances may be selected (e.g., for best fit, for load balancing, etc.) to process a request. In at least one embodiment, to process a request, a request may be entered into a database, a machine learning model may be located from model registry 1124 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1112) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 1020 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1126, and an inference service may perform inferencing on a GPU.

In at least one embodiment, visualization services 1120 may be leveraged to generate visualizations for viewing outputs of applications and/or deployment pipeline(s) 1110. In at least one embodiment, GPUs 1122 may be leveraged by visualization services 1120 to generate visualizations. In at least one embodiment, rendering effects, such as ray-tracing or other light transport simulation techniques, may be implemented by visualization services 1120 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1120 may include an internal visualizer, cinematics, and/or other rendering or image processing capabilities or functionality (e.g., ray tracing, rasterization, internal optics, etc.).

In at least one embodiment, hardware 1022 may include GPUs 1122, AI system 1124, cloud 1126, and/or any other hardware used for executing training system 1004 and/or deployment system 1006. In at least one embodiment, GPUs 1122 (e.g., NVIDIA's TESLA® and/or QUADRO® GPUs) may include any number of GPUs that may be used for executing processing tasks of compute services 1116, collaborative content creation services 1217, AI services 1118, simulation services 1219, visualization services 1120, other services, and/or any of features or functionality of software 1018. For example, with respect to AI services 1118, GPUs 1122 may be used to perform pre-processing on imaging data (or other data types used by machine learning models), post-processing on outputs of machine learning models, and/or to perform inferencing (e.g., to execute machine learning models). In at least one embodiment, cloud 1126, AI system 1124, and/or other components of system 1100 may use GPUs 1122. In at least one embodiment, cloud 1126 may include a GPU-optimized platform for deep learning tasks. In at least one embodiment, AI system 1124 may use GPUs, and cloud 1126—or at least a portion tasked with deep learning or inferencing—may be executed using one or more AI systems 1124. As such, although hardware 1022 is illustrated as discrete components, this is not intended to be limiting, and any components of hardware 1022 may be combined with, or leveraged by, any other components of hardware 1022.

In at least one embodiment, AI system 1124 may include a purpose-built computing system (e.g., a super-computer or an HPC) configured for inferencing, deep learning, machine learning, and/or other artificial intelligence tasks. In at least one embodiment, AI system 1124 (e.g., NVIDIA's DGX™) may include GPU-optimized software (e.g., a software stack) that may be executed using a plurality of GPUs 1122, in addition to CPUs, RAM, storage, and/or other components, features, or functionality. In at least one embodiment, one or more AI systems 1124 may be implemented in cloud 1126 (e.g., in a data center) for performing some or all of AI-based processing tasks of system 1100.

In at least one embodiment, cloud 1126 may include a GPU-accelerated infrastructure (e.g., NVIDIA's NGC™) that may provide a GPU-optimized platform for executing processing tasks of system 1100. In at least one embodiment, cloud 1126 may include an AI system(s) 1124 for performing one or more of AI-based tasks of system 1100 (e.g., as a hardware abstraction and scaling platform). In at least one embodiment, cloud 1126 may integrate with application orchestration system 1028 leveraging multiple GPUs to enable seamless scaling and load balancing between and among applications and services 1020. In at least one embodiment, cloud 1126 may be tasked with executing at least some of services 1020 of system 1100, including compute services 1116, AI services 1118, and/or visualization services 1120, as described herein. In at least one embodiment, cloud 1126 may perform small and large batch inference (e.g., executing NVIDIA's TensorRT™), provide an accelerated parallel computing API and platform 1230 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1100.

In at least one embodiment, in an effort to preserve patient confidentiality (e.g., where patient data or records are to be used off-premises), cloud 1126 may include a registry, such as a deep learning container registry. In at least one embodiment, a registry may store containers for instantiations of applications that may perform pre-processing, post-processing, or other processing tasks on patient data. In at least one embodiment, cloud 1126 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### Example Language Models

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified and/or formats. The styles, tones, LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models- or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

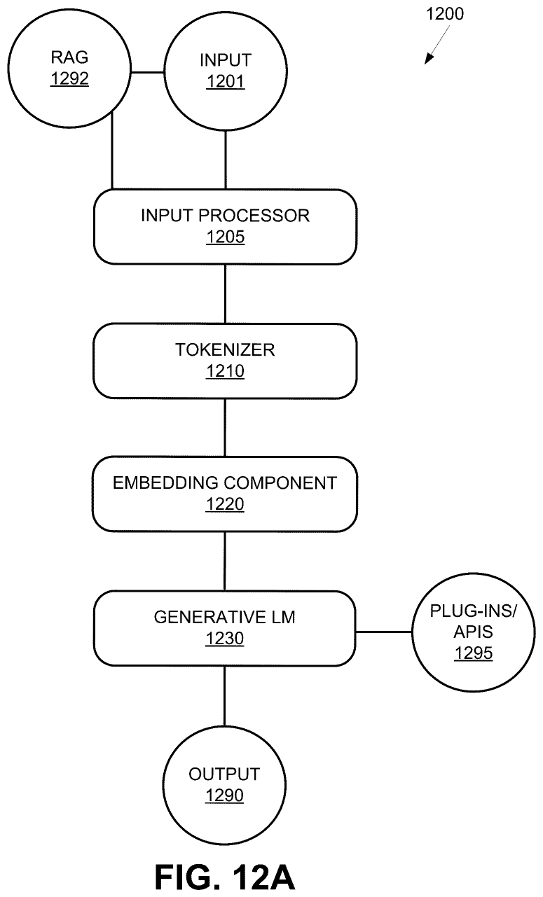

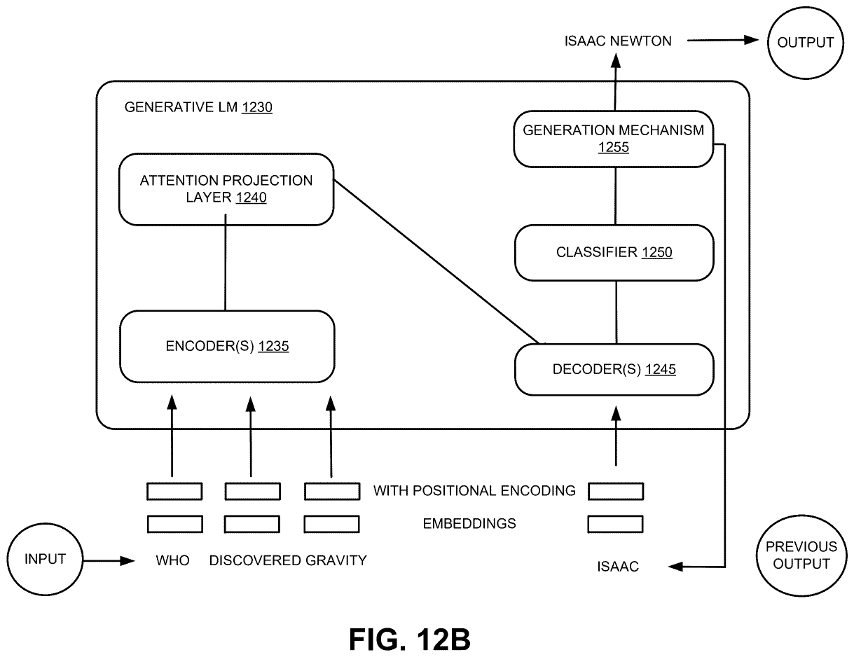

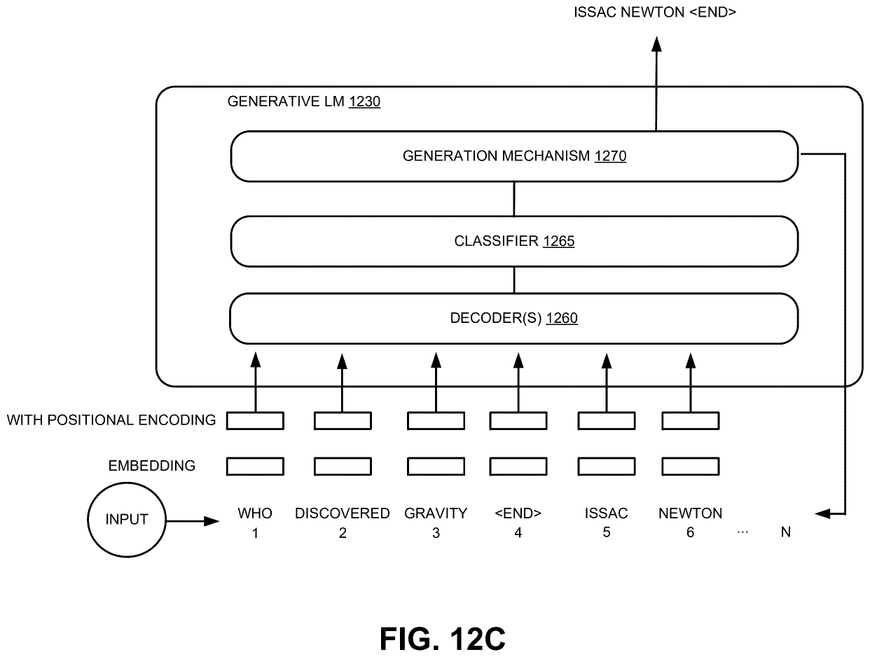

FIG. 12A is a block diagram of an example generative language model system 1200 suitable for use in implementing at least some embodiments of the present disclosure. In the example illustrated in FIG. 12A, the generative language model system 1200 includes a retrieval augmented generation (RAG) component 1292, an input processor 1205, a tokenizer 1210, an embedding component 1220, plug-ins/APIs 1295, and a generative language model (LM) 1230 (which may include an LLM, a SLM, a VLM, a multi-modal LM, etc.).

At a high level, the input processor 1205 may receive an input 1201 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1230 (e.g., LLM/SLMs/VLM/MMLM/etc.). In some embodiments, the input 1201 includes plain text in the form of one or more sentences, paragraphs, and/or documents. Additionally or alternatively, the input 1201 may include numerical sequences, precomputed embeddings (e.g., word or sentence embeddings), and/or structured data (e.g., in tabular formats, JSON, or XML). In some implementations in which the generative LM 1230 is capable of processing multi-modal inputs, the input 1201 may combine text (or may omit text) with image data, audio data, video data, design data, USD data, and/or other types of input data, such as but not limited to those described herein. Taking raw input text as an example, the input processor 1205 may prepare raw input text in various ways. For example, the input processor 1205 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1205 may remove stopwords to reduce noise and focus the generative LM 1230 on more meaningful content. The input processor 1205 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1292 (which may include one or more RAG models, and/or may be performed using the generative LM 1230 itself) may be used to retrieve additional information to be used as part of the input 1201 or prompt. RAG may be used to enhance the input to the LLM/SLMs/VLM/MMLM/etc. with external knowledge, so that answers to specific questions or queries or requests are more relevant-such as in a case where specific knowledge is required. The RAG component 1292 may fetch this additional information (e.g., grounding information, such as grounding text/image/video/audio/USD/CAD/etc.) from one or more external sources, which can then be fed to the LLM/SLMs/VLM/MMLM/etc. along with the prompt to improve accuracy of the responses or outputs of the model.

For example, in some embodiments, the input 1201 may be generated using the query or input to the model (e.g., a question, a request, etc.) in addition to data retrieved using the RAG component 1292. In some embodiments, the input processor 1205 may analyze the input 1201 and communicate with the RAG component 1292 (or the RAG component 1292 may be part of the input processor 1205, in embodiments) in order to identify relevant text and/or other data to provide to the generative LM 1230 as additional context or sources of information from which to identify the response, answer, or output 1290, generally. For example, where the input indicates that the user is interested in a desired tire pressure for a particular make and model of vehicle, the RAG component 1292 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1292 may retrieve a prior stored conversation history- or at least a summary thereof- and include the prior conversation history along with the current ask/request as part of the input 1201 to the generative LM 1230.

The RAG component 1292 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1292 and the embeddings of the chunks along with the embeddings of the query may be compared to identify the most similar/related embeddings to the query, which may be supplied to the generative LM 1230 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLMs/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLMs/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLMs/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1292 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1210 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1230 to understand morphological variations and handle out-of-vocabulary words more effectively. Character-based tokenization represents each character as a separate token, enabling the generative LM 1230 to process text at a fine-grained level. The choice of tokenization strategy may depend on factors such as the language being processed, the task at hand, and/or characteristics of the training dataset. As such, the tokenizer 1210 may convert the (e.g., processed) text into a structured format according to tokenization schema being implemented in the particular embodiment.

The embedding component 1220 may use any known embedding technique to transform discrete tokens into (e.g., dense, continuous vector) representations of semantic meaning. For example, the embedding component 1220 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1201 includes image data/video data/etc., the input processor 1201 may resize the data to a standard size compatible with format of a corresponding input channel and/or may normalize pixel values to a common range (e.g., 0 to 1) to ensure a consistent representation, and the embedding component 1220 may encode the image data using any known technique (e.g., using one or more convolutional neural networks (CNNs) to extract visual features). In some implementations in which the input 1201 includes audio data, the input processor 1201 may resample an audio file to a consistent sampling rate for uniform processing, and the embedding component 1220 may use any known technique to extract and encode audio features—such as in the form of a spectrogram (e.g., a mel-spectrogram). In some implementations in which the input 1201 includes video data, the input processor 1201 may extract frames or apply resizing to extracted frames, and the embedding component 1220 may extract features such as optical flow embeddings or video embeddings and/or may encode temporal information or sequences of frames. In some implementations in which the input 1201 includes multi-modal data, the embedding component 1220 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1230 and/or other components of the generative LM system 1200 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1220 may apply an encoded representation of the input 1201 to the generative LM 1230, and the generative LM 1230 may process the encoded representation of the input 1201 to generate an output 1290, which may include responsive text and/or other types of data.

As described herein, in some embodiments, the generative LM 1230 may be configured to access or use—or capable of accessing or using—plug-ins/APIs 1295 (which may include one or more plug-ins, application programming interfaces (APIs), databases, data stores, repositories, etc.). For example, for certain tasks or operations that the generative LM 1230 is not ideally suited for, the model may have instructions (e.g., as a result of training, and/or based on instructions in a given prompt, such as those retrieved using the RAG component 1292) to access one or more plug-ins/APIs 1295 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1295 to the plug-in/API 1295, the plug-in/API 1295 may process the information and return an answer to the generative LM 1230, and the generative LM 1230 may use the response to generate the output 1290. This process may be repeated—e.g., recursively—for any number of iterations and using any number of plug-ins/APIs 1295 until an output 1290 that addresses each ask/question/request/process/operation/etc. from the input 1201 can be generated. As such, the model(s) may not only rely on its own knowledge from training on a large dataset(s) and/or from data retrieved using the RAG component 1292, but also on the expertise or optimized nature of one or more external resources-such as the plug-ins/APIs 1295.

FIG. 12B is a block diagram of an example implementation in which the generative LM 1230 includes a transformer encoder-decoder. For example, assume input text such as “Who discovered gravity” is tokenized (e.g., by the tokenizer 1210 of FIG. 12A) into tokens such as words, and each token is encoded (e.g., by the embedding component 1220 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1235 of the generative LM 1230.

In an example implementation, the encoder(s) 1235 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1240 may convert the context vector into attention vectors (keys and values) for the decoder(s) 1245.

In an example implementation, the decoder(s) 1245 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1235, in an example transformer architecture, each token (e.g., word) flows through a separate path in the decoder(s) 1245. During a first pass, the decoder(s) 1245, a classifier 1250, and a generation mechanism 1255 may generate a first token, and the generation mechanism 1255 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1245 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1235, except that it creates its queries from the layer below it and takes the keys and values (e.g., matrix) from the output of the encoder(s) 1235.

As such, the decoder(s) 1245 may output some decoded (e.g., vector) representation of the input being applied during a particular pass. The classifier 1250 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1255 may select or sample a word or token based on a corresponding predicted probability (e.g., select the word with the highest predicted probability) and append it to the output from a previous pass, generating each word or token sequentially. The generation mechanism 1255 may repeat the process, triggering successive decoder inputs and corresponding predictions until selecting or sampling a symbol or token that represents the end of the response, at which point, the generation mechanism 1255 may output the generated response.

FIG. 12C is a block diagram of an example implementation in which the generative LM 1230 includes a decoder-only transformer architecture. For example, the decoder(s) 1260 of FIG. 12C may operate similarly as the decoder(s) 1245 of FIG. 12B except each of the decoder(s) 1260 of FIG. 12C omits the encoder-decoder self-attention layer (since there is no encoder in this implementation). As such, the decoder(s) 1260 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1260. As with the decoder(s) 1245 of FIG. 12B, each token (e.g., word) may flow through a separate path in the decoder(s) 1260, and the decoder(s) 1260, a classifier 1265, and a generation mechanism 1270 may use auto-regression to sequentially generate one token at a time until predicting a symbol or token that represents the end of the response. The classifier 1265 and the generation mechanism 1270 may operate similarly as the classifier 1250 and the generation mechanism 1255 of FIG. 12B, with the generation mechanism 1270 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

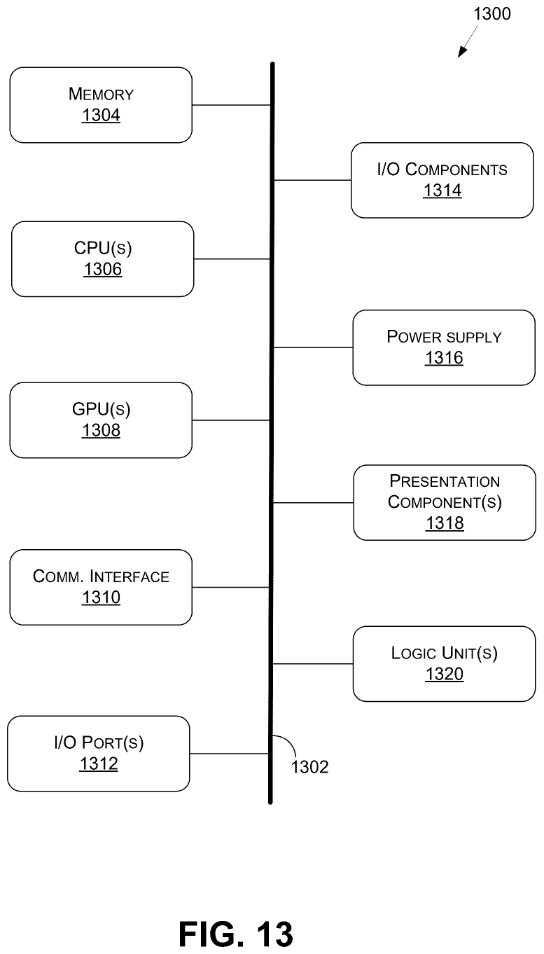

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 12 Are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). As such, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that allow the computing device 1300 to communicate with other computing devices via an electronic communication network, included wired and/or wireless communications. The communication interface 1310 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may allow the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that allow detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to allow the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing computing device (“CPU”) executes some of instructions while a graphics processing computing device (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
allocating, at a first point in time during a task execution, a first portion of memory resources of a graphics processing unit (GPU) to a first set of at least one computational model of a plurality of computational models, wherein the first set of at least one computational model requires an amount of memory resources less than the first portion of memory resources;
identifying, at a second point in time during the task execution, a second set of at least one computational model of the plurality of computational models for continuation of the task execution;
determining that a second portion of the memory resources of the GPU is insufficient for the second set of at least one computational model; and
reallocating a third portion of memory resources of the GPU to the second set of at least one computational model.

2. The method of claim 1, wherein the second portion of memory resources is a portion of memory resources that remains unallocated after the first portion of memory resources is allocated to the first set of at least one computational model, and wherein the third portion of memory resources includes at least a sub-portion of the first portion of memory resources.

3. The method of claim 1, wherein the first portion of memory resources and the second portion of memory resources are committed to task execution using the plurality of computational models, wherein the second portion of memory resources is a portion of memory resources that remains unallocated after the first portion of memory resources is allocated to the first set of at least one computational model, and wherein the third portion of memory resources is committed to executing a GPU application.

4. The method of claim 3, wherein reallocating the third portion of memory resources of the GPU to the second set of at least one computation model further comprises:
identifying the third portion of memory resources, wherein the third portion of memory resources comprises idle memory resources committed to executing the GPU application;
allocating the third portion of memory resources to the second set of at least one computational model;
executing the second set of at least one computational model; and
deallocating the third portion of memory resources from the second set of at least one computational model.

5. The method of claim 1, wherein the first portion of memory resources and the third portion of memory resources is a same portion of memory resources of the GPU.

6. The method of claim 1, further comprising:
identifying a plurality of modes;
selecting, for a first mode of the plurality of modes, the first set of at least one computational model based on memory capacity of the GPU; and
selecting, for a second mode of the plurality of modes, the second set of at least one computational model based on the memory capacity of the GPU.

7. The method of claim 1, wherein:
the first portion of memory resources of the GPU is allocated to a first sub-portion of the first portion of memory resources;
the second portion of memory resources is a portion of memory resources that remains unallocated after the first sub-portion of the first portion of memory resources is allocated to the first set of at least one computational model;
the third portion of memory resources is a second sub-portion of the first portion of memory resources; and
reallocating the third portion of memory resources of the GPU to the second set of at least one computational model further comprises:
identifying a computational model of the first set of at least one computational model to maintain in the first sub-portion of the first portion of memory resources;
determining that the second sub-portion of the first portion of memory resources is sufficient for the second set of at least one computational model; and
reallocating the second sub-portion of the first portion of memory resources to the second set of at least one computational model.

8. The method of claim 1, wherein identifying the second set of at least one computation model for continuation of the task execution further comprises:
identifying a memory resource requirement for at least one computational model of the plurality of computational models; and
selecting one or more computational models for the second set of at least one computational model based on the amount of memory resources of the first portion.

9. A scheduler, the scheduler comprising:
a processing unit; and
a memory storing one or more executable instructions that when executed by the processing unit cause the scheduler to:
allocating, at a first point in time during a task execution, a first portion of memory resources of a graphics processing unit (GPU) to a first set of at least one computational model of a plurality of computational models;
identifying, at a second point in time during the task execution, a second set of at least one computational model of the plurality of computational models for continuation of the task execution;
determining that a second portion of the memory resources of the GPU is insufficient for the second set of at least one computational model; and
reallocating a third portion of memory resources of the GPU to the second set of at least one computational model.

10. The scheduler of claim 9, wherein the second portion of memory resources is a portion of memory resources that remains unallocated after the first portion of memory resources is allocated to the first set of at least one computational model, and wherein the third portion of memory resources includes at least a sub-portion of the first portion of memory resources.

11. The scheduler of claim 9, wherein the first portion of memory resources and the second portion of memory resources are committed to task execution using the plurality of computational models, wherein the second portion of memory resources is a portion of memory resources that remains unallocated after the first portion of memory resources is allocated to the first set of at least one computational model, and wherein third portion of memory resources is committed to executing a GPU application.

12. The scheduler of claim 9, wherein reallocating a third portion of memory resources of the GPU to the second set of at least one computation model further comprises:
identifying the third portion of memory resources, wherein the third portion of memory resources comprises idle memory resources committed to executing the GPU application;
allocating the second portion of memory resources to the second set of at least one computational model;
executing the second set of at least one computational model; and
deallocating the third portion of memory resources from the second set of at least one computational model.

13. The scheduler of claim 9, wherein the first portion of memory resources and the third portion of memory resources is a same portion of memory resources of the GPU.

14. The scheduler of claim 9, further comprising one or more executable instructions that when executed by the processing unit cause the scheduler to:
identifying a plurality of modes; and
selecting, for a first mode of the plurality of modes, the first set of at least one computational model based on memory capacity of the GPU;
selecting, for a second mode of the plurality of modes, the second set of at least one computational model based on the memory capacity of the GPU.

15. The scheduler of claim 9, wherein
the first portion of memory resources of the GPU is allocated to a first sub-portion of the first portion of memory resources;
the second portion of memory resources is a portion of memory resources that remains unallocated after the first sub-portion of the first portion of memory resources is allocated to the first set of at least one computational model;
the third portion of memory resources is a second sub-portion of the first portion of memory resources; and
reallocating the third portion of memory resources of the GPU to the second set of at least one computational model further comprises:
identifying a computational model of the first set of at least one computational model to maintain in the first sub-portion of the first portion of memory resources;
determining that the second sub-portion of the first portion of memory resources is sufficient for the second set of at least one computational model; and
reallocating the second sub-portion of the first portion of memory resources to the second set of at least one computational model.

16. The scheduler of claim 9, wherein identifying the second set of at least one computation model for continuation of the task execution further comprises:
identifying a memory resource requirement for at least one computational model of the plurality of computational models; and
selecting one or more computational models for the second set of at least one computational model based on the amount of memory resources of the first portion.

17. A system, the system comprising:
a first processor;
a second processor to perform operations comprising:
allocate a first portion of memory resources of the first processor to a first set of at least one computational model of a plurality of computational models;
identify a second set of at least one computational model of the plurality of computational models for continuation of the task execution;
determine that a second portion of the memory resources of the first processor is insufficient for the second set of at least one computational model; and
reallocate a third portion of memory resources of the first processor to the second set of at least one computational model.

18. The system of claim 17, wherein the second portion of memory resources is a portion of memory resources that remains unallocated after the first portion of memory resources is allocated to the first set of at least one computational model, and wherein the third portion of memory resources includes at least a sub-portion of the first portion of memory resources.

19. The system of claim 17, wherein the first portion of memory resources and the second portion of memory resources are committed to task execution using the plurality of computational models, wherein the second portion of memory resources is a portion of memory resources that remains unallocated after the first portion of memory resources is allocated to the first set of at least one computational model, and wherein the third portion of memory resources is committed to executing a GPU application.

20. The system of claim 17, wherein the first portion of memory resources and the third portion of memory resources is a same portion of memory resources of the first processor.
